(19) United States
(12) Patent Application Publication
(10) Pub. No.: US 2016/0329072 A1
(43) Pub. Date: Nov. 10, 2016

(54) ONE OR MORE NON-DISK DISK DRIVE COMPONENTS HAVING A LUBRICANT COMPOSITION THAT IS MISCIBLE WITH A DISK MEDIA LUBRICANT COMPOSITION

(71) Applicant: Seagate Technology LLC, Cupertino, CA (US)

(72) Inventors: Michael Joseph Stirniman, Fremont, CA (US); Pamela K. Gobran, Maplewood, MN (US); Alexei Hiram Sacks, Minnetonka, MN (US)

(21) Appl. No.: 14/704,371

(22) Filed: May 5, 2015

(51) Int. Cl. G11B 5/725; C10M 107/38

(52) U.S. Cl. CPC G11B 5/725; C10M 107/38

(57) ABSTRACT

The present disclosure is directed to disk drives that have one or more disks and one or more additional disk drive components. The one or more disk can include a first lubricant composition. The one or more additional disk drive components can include a second lubricant composition that is miscible with the first lubricant composition. In some embodiments, the first lubricant composition and the second lubricant composition are the same.

### BACKGROUND

Disk drives can include one or more disks and one or more components in addition to the disks. A variety of lubricants can be used with variety of disk drive components.

### SUMMARY

Disclosed in embodiments herein are a disk drive including:

a base;

one or more disks rotatably coupled to the base, wherein each of the one or more disks includes a first major surface and a second major surface, wherein a first lubricant composition is present on at least a portion of the first major surface and/or the second major surface, and wherein the first lubricant composition includes a perfluoropolyether polymer having one or more polar functional groups;

at least one additional disk drive component including a surface, wherein a second lubricant composition is present on at least a portion of the surface of the at least one additional disk drive component, wherein the second lubricant composition is miscible in the first lubricant composition; and

a lid physically coupled to the base, wherein the lid encloses the one or more disks and the at least one additional disk drive component.

### BRIEF DESCRIPTION OF THE DRAWINGS

FIG. 1 is a perspective view of an embodiment of a disk drive, showing the inside of the disk drive;

FIG. 2 is a perspective view of a portion of the disk drive in FIG. 1, showing the inside of the disk drive with the top plate of the voice coil motor removed;

FIG. 3 is a cross-sectional elevation view of a schematic illustration of an embodiment of a disk, showing a layer of lubricant on the first major surface and second major surface; and

FIG. 4 is a cross-section al view of schematic illustration of an embodiment of a coil wire.

### DETAILED DESCRIPTION

Embodiments of the present disclosure include a disk drive having a base; one or more disks rotatably coupled to the base; at least one additional disk drive component having a surface; and a lid physically coupled to the base. Each of the one or more disks includes a first major surface and a second major surface. A first lubricant composition is present on at least a portion of the first major surface and/or the second major surface of the one or more disks, and a second lubricant composition is present on at least a portion of the surface of the at least one additional disk drive component. The lid encloses the one or more disks and the at least one additional disk drive component.

A disk can have a plurality of layers in addition to a lubricating layer. For example, a disk structure can include a protective layer overlaying a magnetic recording layer, where the magnetic recording layer overlies a nonmagnetic substrate. A protective layer can include carbon, hydrogenated carbon, nitrogenated carbon, and the like. A lubricating layer including the first lubricant composition can overlay the protective layer.

Additional Disk Drive Components

A disk drive according to the present disclosure can include at least one disk drive component in addition to the disk or disks and that includes a lubricant composition. As mentioned above and discussed below, the disk or disks have a “first” lubricant composition and the additional disk drive component has a “second” lubricant composition. Each of the first lubricant composition and second lubricant composition are discussed in detail below.

An additional disk drive component may include a second lubricant composition and at least a portion of the second lubricant composition may transfer to one or more disks. While not being bound by theory, at least a portion of the second lubricant composition may transfer from an additional disk drive component to one or more disks by one or more mechanisms. For example, the second lubricant composition may transfer to one or more disks via a diffusion path. As another example, the second lubricant composition may transfer to one or more disks by evaporating (e.g., due to changes in temperature of the environment and//or a component) and then condensing on the one or more disks. As yet another example, the second lubricant composition may transfer to one or more disks by forming an aerosol and depositing on the one or more disks. As yet another example, the second lubricant composition may transfer to one or more disks by becoming entrained in an airstream and then depositing on one or more disks. Exemplary additional disk drive components that can include a second lubricant composition include a voice coil, a spindle coil, a solenoid coil, a filter patch, a damper, a head gimbal assembly (HGA), a trace gimbal assembly (TGA), a pressure sensitive adhesive assembly, and the like, and combinations thereof. Such additional disk drive components can have a second lubricant composition present for a variety of reasons. For example, a second lubricant composition may be present because it was used to manufacture the component and was not partially or completely removed afterwards.

With respect to a coil such as a voice coil, a second lubricant composition may be used to provide the voice coil wire with desirable friction properties during one or more of spooling, despooling, and coil winding operations. For example, a second lubricant composition may help prevent the coil wire from sticking to itself during spooling and despooling. Further, a second lubricant composition may help provide the coil wire with a constant friction during the coil winding process and facilitate consistent spacing among adjacent portions of wire. During disk drive operation, electric current can pass through the voice coil and resistively heat the voice coil which may cause at least a portion of the layer of the second lubricant composition to transfer to one or more disks. As discussed below, the second lubricant composition is selected to be miscible with the first lubricant composition on the disks so that the transferred second lubricant composition can mix with the first lubricant composition and spread out instead of forming droplets. Advantageously, by reducing the tendency of the second lubricant composition to form droplets on a disk, disk drive failures due to a slider head contacting such droplets can be reduced or eliminated.

With respect to additional disk drive components such as a filter patch, a damper, a head gimbal assembly, a trace gimbal assembly, and the like, a second lubricant composition may be present as part of a pressure sensitive adhesive assembly that is applied to the component so as to attach the component within the disk drive. For example, a second lubricant composition may be present as part of a release liner and/or a release coating. After the pressure sensitive adhesive is applied to the component and the release liner removed, at least a portion of the second lubricant composition may remain with the pressure sensitive adhesive when the component is attached within the disk drive. After the disk drive is assembled, at least a portion of the second lubricant composition may transfer to one or more disks. As discussed below, the second lubricant composition is selected to be miscible with the first lubricant composition on the disks so that the transferred second lubricant composition can mix with the first lubricant composition and spread out instead of forming droplets. Advantageously, by reducing the tendency of the second lubricant composition to form droplets on a disk, disk drive failures due to a slider head contacting such droplets can be reduced or eliminated.

Optionally, at least a portion of the inside surfaces of a disk drive housing (e.g., the lid and base) can include the second lubricant composition as well.

First Lubricant Composition

Embodiments of the present disclosure can include one or more disks having a first lubricant composition that is present on at least a portion of the first major surface and/or the second major surface of the one or more disks.

The first lubricant composition can be selected based on one or more factors. For example, the first lubricant composition can lubricate and reduce friction of the interface between a major surface of a disk and a slider. Reducing the friction between a major surface of a disk and a slider can help avoid stiction between the disk and the slider. Stiction can occur when two relatively smooth surfaces stick to each other. In some contexts, the stiction can effectively prevent separating the two surfaces. For example, a disk surface and a magnetic recording face of a slider can have relatively smooth surfaces. These smooth surfaces can help facilitate low fly height of the slider relative to the disk that is associated with high density recording. The smooth surfaces may contact each other, for example, when the disk is not rotating. Stiction forces may be sufficient between the slider and the disk so as to prevent rotation of the disk when it is desired to rotate the disk. If the disk cannot be rotated, damage may occur to the surface of the disk or slider due to the fact that the slider is in contact with and stuck to the disk surface as the disk moves relative to the slider. A first lubricant composition can also suppress wear between the disk and the slider.

In embodiments of the present disclosure, the first lubricant composition includes a perfluoropolyether polymer having one or more polar functional groups.

In some embodiments, a perfluoropolyether (PFPE) polymer according to the present disclosure has a backbone of repeating units according to the following structure:

(CF₂)ₙ—O

wherein n is an integer from 1 to 4.

In some embodiments, a perfluoropolyether (PFPE) polymer according to the present disclosure has a backbone of repeating units according to the following structure:

O—(CF₂CF₂O)ₘ(CF₂)_{n}

Wherein n is an integer from 1 to 4 and m is an integer from 1 to 4.

A polar functional group can be present as a side group, an end group, and combinations thereof. In some embodiments, the PFPE backbone is terminated with at least one polar end group. In some embodiments, the PFPE backbone is terminated with two polar end groups. In some embodiments, the PFPE backbone is terminated with two polar end groups per end of the PFPE polymer.

In some embodiments, the one or more polar functional groups can include a hydroxyl, a carboxyl, an amine, derivatives thereof, and combinations thereof. In some embodiments, a polar functional group may be cross-linkable via thermal radiation and/or UV radiation. In some embodiments, the PFPE backbone is terminated with two hydroxyl end groups per end of the PFPE polymer. In some embodiments, it can be desirable to select the first lubricant composition so that at least a portion of the first lubricant composition is bonded to the disk to help the first lubricant composition remain on the disk during use. For example, a PFPE can be treated via UV radiation and/or thermal energy so that a functional group such as hydroxyl bonds to the disk.

Suitable PFPE polymers having at least one polar functional group are commercially available. An example of a commercially available PFPE polymer having a hydroxyl end group is sold under the trade name Fomblin® Z-Tetraol from Solvay.

Optionally, the first lubricant composition can include one or more additives to help prevent degradation and/or destabilization of the first lubricant composition, adjust the viscosity of the first lubricant composition, and the like.

The first lubricant composition can be applied to disk by known techniques such as dip coating a solution having a solvent carrier or physical vapor deposition.

The first lubricant composition can be applied to a disk at any desired thickness such as a thickness in the range from 0.1 to 5 nanometers, or even from 0.5 to 2 nanometers.

Exemplary lubricants for use in a first lubricant composition are also described in U.S. Pat. No. 6,083,600 (Kasai et al.), U.S. Pub. No. 2005/0282045, U.S. Pub. No. 2011/0305923 (Karis et al.), and U.S. Pub. No. 2013/0194693 (Amo et al.), the entireties of which patent and publications are incorporated herein by reference.

Second Lubricant Composition

Embodiments of the present disclosure can include at least one additional disk drive component having a second lubricant composition that is miscible with the first lubricant composition. The second lubricant composition is miscible with the first lubricant composition if the two lubricant compositions form a single lubricant phase when mixed such that no meniscus forms between them. For example, a problem with some lubricant compositions on non-disk components within a disk drive is that they are not miscible with disk media lubricants such that they can form droplets on the media lubricant if they transfer to a surface of the disk. Unfortunately, such droplets can cause disk failures during read/write operations if a slider head contacts and/or picks up such droplets. A second lubricant according to the present disclosure can be miscible with a first lubricant composition on a disk such that if the second lubricant composition transfers from a non-disk component (e.g., a voice coil) to the disk, the second lubricant composition can mix with the first lubricant composition and not form a droplet. Further, if the second lubricant composition deposits on a layer of the first lubricant composition that is on a surface of a disk, the second lubricant composition can mix with the first lubricant composition and spread out so as to form a relatively uniform layer thickness. The amount of second lubricant composition that deposits on a layer of the first lubricant composition tends to be relatively small such that the thickness of the layer before such deposition relative to the thickness of the layer after such deposition can be relatively small and does not impact read-write operations to an undue degree.

In addition to miscibility with the first lubricant composition, the second lubricant composition can be selected based a variety of factors. For example, the viscosity of the second lubricant can be selected so that the second lubricant composition can be applied in a desirable manner to one or more non-disk disk drive components.

In some embodiments, the second lubricant composition includes a perfluoropolyether polymer having one or more polar functional groups.

In some embodiments, a perfluoropolyether (PFPE) polymer according to the present disclosure has a backbone of repeating units according to the following structure:

(CF₂)ₙ—O

wherein n is an integer from 1 to 4.

In some embodiments, a perfluoropolyether (PFPE) polymer according to the present disclosure has a backbone of repeating units according to the following structure:

O—(CF₂CF₂O)ₘ(CF₂)ₙ

Wherein n is an integer from 1 to 4 and m is an integer from 1 to 4.

A polar functional group can be present as a side group, an end group, and combinations thereof. In some embodiments, the PFPE backbone is terminated with at least one polar end group. In some embodiments, the PFPE backbone is terminated with two polar end groups. In some embodiments, the PFPE backbone is terminated with two polar end groups per end of the PFPE polymer.

In some embodiments, the one or more polar functional groups can include a hydroxyl, a carboxyl, an amine, derivatives thereof, and combinations thereof. In some embodiments, the PFPE backbone is terminated with two hydroxyl end groups per end of the PFPE polymer. In some embodiments, a polar functional group may be cross-linkable via thermal radiation and/or UV radiation.

Suitable PFPE polymers having at least one polar functional group are commercially available. An example of a commercially available PFPE polymer having a hydroxyl end group is sold under the trade name Fomblin® Z-Tetraol from Solvay.

Optionally, the second lubricant composition can include one or more additives to help prevent degradation and/or destabilization of the second lubricant composition, adjust the viscosity of the second lubricant composition, and the like.

In some embodiments, the second lubricant composition is the same as the first lubricant composition. In some embodiments, the second lubricant composition is different from the first lubricant composition.

In some embodiments, the first lubricant composition includes a perfluoropolyether polymer having at least one hydroxyl functional end group and the second lubricant composition includes a perfluoropolyether polymer having at least one hydroxyl functional end group.

In some embodiments, a plurality of additional disk drive components may each have lubricant compositions that are the same as or different from each other. If the lubricant compositions on the additional disk components are different (e.g., second lubricant composition, third lubricant composition, etc.) from each other, then each lubricant composition can still be miscible with the first lubricant composition that is present on a disk or disks. Accordingly, in one embodiment, a first additional disk drive component includes a surface having a second lubricant composition that is present on at least a portion of the surface of the first additional disk drive component, and a second additional disk drive component includes a surface having a third lubricant composition that is present on at least a portion of the surface of the second additional disk drive component. The second lubricant composition is miscible in the first lubricant composition, and the third lubricant composition is miscible in the first lubricant composition.

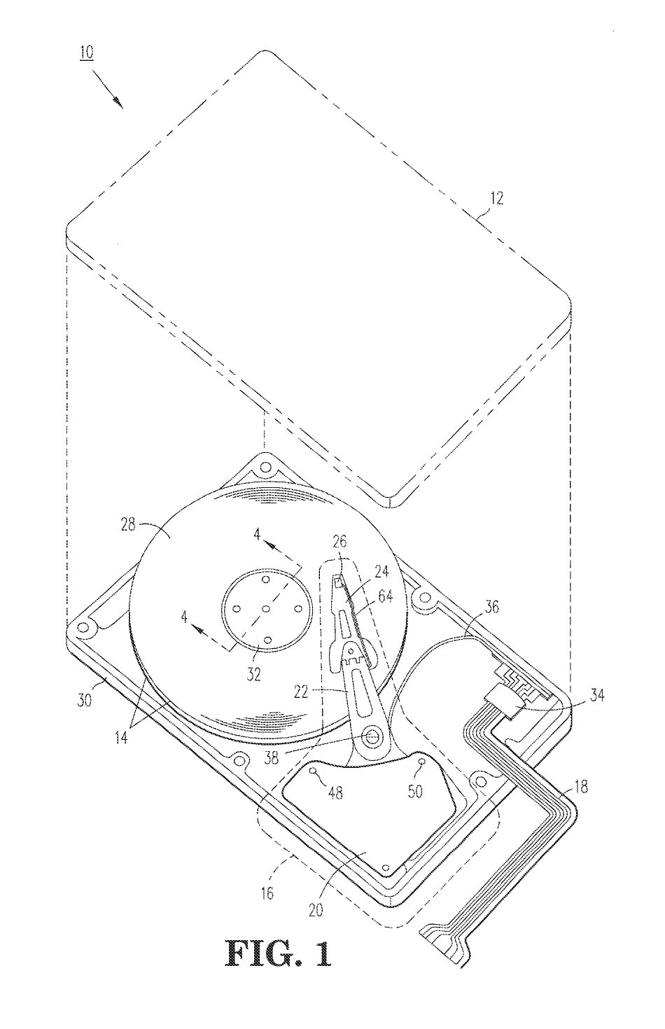

An embodiment of a disk drive according to the present disclosure is described herein below using FIGS. 1, 2, 3, and 4. The “additional disk drive component” illustrated with respect to this embodiment is a voice coil.

FIG. 1 shows a disk drive 10 that includes a base 30 supporting a plurality of disks 14. A lid 12 is shown exploded and in phantom. In operation, the lid 12 can be disposed atop of base 30. Lid 12 can be attached to base 30 so as to enclose the one or more disks 14 and the other disk drive components supported on base 30.

As shown, disk drive 10 includes a plurality of disks 14. The disks 14 may be magnetic conventional particulate or thin film recording disks, which are capable of storing digital data. In some embodiments, both sides of the disks 14 are available for storage. Disk drive 10 may include any number of such disks 14.

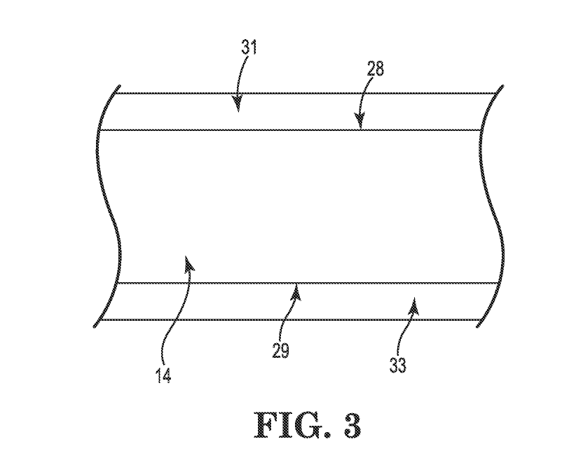

As shown in FIG. 3, each of the disks 14 includes a first major surface 28 and a second major surface 29 opposite the first major surface 28. A first lubricant composition is present on at least a portion of the first major surface 28 and/or the second major surface 29 of one or more disks 14. As shown in FIG. 3, a layer 31 of first lubricant composition is present on the first major surface 28 and a layer 33 of first lubricant composition is present on second major surface 29.

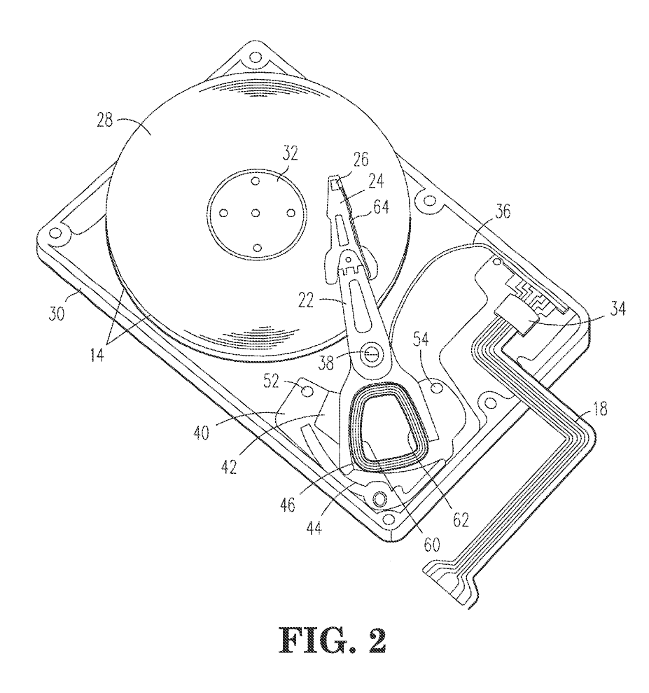

As shown in FIG. 2, disks 14 are mounted to a spindle 32. As shown, the spindle 32 is attached to a spindle motor (not shown) which can rotate the spindle 32 and the disks 14 to provide read/write access to the various portions of the concentric tracks on the disks 14.

An actuator assembly 16 is indicated by the dashed lines in FIG. 1. The actuator assembly 16 includes a positioner arm 22, and a suspension assembly 24. The suspension assembly 24 includes a read/write head 26 at its distal end. Suspension assembly 24 and read/write head form part of a head gimbal assembly (HGA). Disk drive 10 can be single-sided or double-sided. Although only one read write head 26 of the suspension assembly 24 is shown in FIG. 1, disk drive 10 may have one read/write head 26 for each side of each disk 14 included in the drive 10. The positioner arm 22 further includes a pivot 38 around which the positioner arm 22 can pivot.

The disk drive 10 further includes read/write chip 34. The read/write chip 34 can cooperate with the read/write heads 26 to read from or write to the disks 14. A flexible printed circuit member 36 can carry digital signals between the chip 34 and the actuator assembly 16. One or more electrical conductors 64 can be routed along the pivot arm 22 and suspension assembly 24 to carry electrical signals to and from the read/write head 26. A separate flexible printed circuit member 18 can interface with the chip 34 and associated drive electronics (not shown).

One of the functions of the actuator assembly 16 is to move the positioner arm 22 around pivot 38 using a voice coil motor (vcm). A voice coil motor can power movement of the actuator assembly 16. As shown in FIG. 1 and FIG. 2, vcm includes vcm bottom plate 40, magnet 42, electrically conductive voice coil 46, and vcm top plate 20. In operation, the vcm can position the actuator assembly 16. Referring now to FIG. 2, a perspective view of the disk drive 10 is shown with the vcm top plate 20 removed from the actuator assembly 16 to show the interior of the actuator assembly 16. As shown in FIG. 2, actuator assembly 16 includes vcm bottom plate 40 and magnet 42. Magnet 42 may be a single magnet or more than one magnet (e.g., a pair of magnets). When the vcm is assembled, the vcm top plate 20 is spaced above the vcm bottom plate 40 and magnet 42 with spacers 48 and 50 (see FIG. 1). The spacers 48 and 50 are magnetic stand-offs. The vcm top plate 20 is positioned above the vcm bottom plate 40 and the magnet 42 by mating the standoffs 48 and 50 with openings 52 and 54 in the vcm bottom plate 40 respectively. As mentioned, actuator assembly 16 further includes a voice coil 46 that is electrically conductive. The voice coil 46 includes wires 78 and has portions 60 and 62 which overlie the magnet 42 in a plane parallel to the magnet 42. In operation, current can pass through the coil portions 60 and 62 and interact with the magnetic field of the magnet 42 so as to rotate the positioner arm 22 and suspension assembly 24 around the pivot 38, thus positioning the read/write head 26 as desired. Also shown in FIG. 2 is a latching mechanism 44, which can serve to secure the position of the actuator assembly 16 when the disk drive 10 is not in operation.

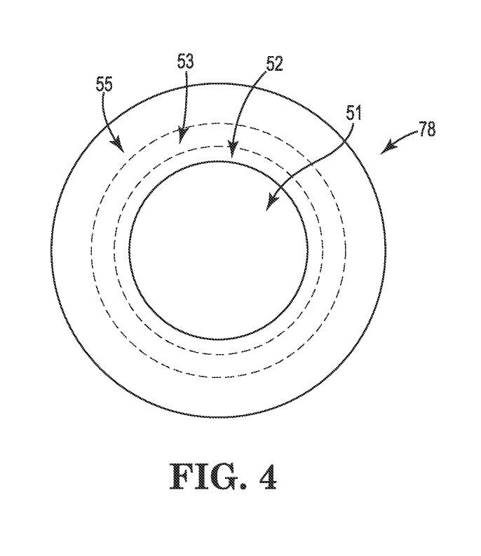

An example of a coil wire 78 for voice coil 46 and spindle motor assembly is shown in FIG. 4 in a cross sectional view. As shown, wire 78 includes at least a conductive core 51 and layer 55 of the second lubricant composition. Conductive core 51 can include a conductive metal such as copper or aluminum. The conductive core 51 can be selected to meet the specific operating parameters and acceptable resistance for a particular application.

Optionally, as indicated by dashed lines, overlaying the conductive core 51 between conductive core 51 and layer 55 of the second lubricant composition can be an insulation layer 52. Insulation layer 52 can function as a temperature resistant covering such as a polyurethane or a polyesterimide resin which can help the conductive core 51 from short circuiting.

Optionally, as indicated by dashed lines, overlaying insulation layer 52 between the insulation layer 52 and layer 55 of the second lubricant composition can be an adhesive bond coat 53. Bond coat 53 can be an adhesive coating applied to the wire to form a coil such as voice coil 46 to facilitate the shaping and winding of the voice coil 46. An example of a material used as a bond coat includes a polyamide adhesive resin.

The layer 55 of the second lubricant composition can help prevent the coil wire 78 from sticking to itself prior to the wire 78 being wound into the voice coil 46.

When the disk drive 10 is being operated, current can be pass through voice coil 46 to actuate and position the read/write head 26 over the desired position on first major surface 28 of the disk 14. As current passes through the voice coil 46, the voice coil 46 can increase in temperature. In some embodiments, the temperature of the voice coil 46 can reach and even exceed 100 degrees Celsius during operation. As the temperature in the voice coil 46 increases, at least a portion of the lubricant layer 55 can transfer to the disk 14 (e.g., first major surface 28 and/or second major surface 29) where the temperature can be relatively cooler. Because the second lubricant composition from layer 55 is miscible with the first lubricant composition in layer 31 and layer 33, the second lubricant composition can transfer and become part of layer 31 and/or layer 33 without forming immiscible drops on the top of layer 31 and/or layer 33. As the second lubricant composition deposits on layer 31 and/or layer 33 on disk 14, the second lubricant composition can mix with the first lubricant composition and spread out so as to form a relatively uniform layer thickness as shown in FIG. 3. The amount of second lubricant composition that transfers to layer 31 and/or layer 33 tends to be relatively small such that the thickness of layer 31 and/or layer 33 before such deposition relative to the thickness after such deposition can be relatively small. Advantageously, because the second lubricant composition is miscible with the first lubricant composition and does not form droplets, disk failures caused by droplets due to immiscible lubricants can be avoided during read/write operations.

Disk drives are also described in U.S. Pat. No. 6,392,846 (Brown et al.) and U.S. Pat. No. 6,608,732 (Bernett et al.), the entirety of which patents are each incorporated herein by reference.

What is claimed is:

1. A disk drive comprising:
a base;
one or more disks rotatably coupled to the base, wherein each of the one or more disks comprises a first major surface and a second major surface, wherein a first lubricant composition is present on at least a portion of the first major surface and/or the second major surface, and wherein the first lubricant composition comprises a perfluoropolyether polymer having one or more polar functional groups;
at least one additional disk drive component comprising a surface, wherein a second lubricant composition is present on at least a portion of the surface of the at least one additional disk drive component, wherein the second lubricant composition is miscible in the first lubricant composition; and
a lid physically coupled to the base, wherein the lid encloses the one or more disks and the at least one additional disk drive component.

2. The disk drive according to claim 1, wherein the second lubricant composition comprises a perfluoropolyether polymer having one or more polar functional groups.

3. The disk drive according to claim 2, wherein the first lubricant composition and the second lubricant composition are the same.

4. The disk drive according to claim 2, wherein the first lubricant composition and the second lubricant composition are different.

5. The disk drive according to claim 1, wherein the one or more polar functional groups are chosen from a hydroxyl, a carboxyl, an amine, derivatives thereof, and combinations thereof.

6. The disk drive according to claim 1, wherein the first lubricant composition comprises a perfluoropolyether polymer having at least one hydroxyl functional end group and the second lubricant composition comprises a perfluoropolyether polymer having at least one hydroxyl functional end group.

7. The disk drive according to claim 1, wherein the first lubricant composition comprises a perfluoropolyether polymer terminated with two polar functional end groups on each end and the second lubricant composition comprises a perfluoropolyether polymer terminated with two polar functional end groups on each end.

8. The disk drive according to claim 1, wherein the first lubricant composition comprises a perfluoropolyether polymer terminated with two hydroxyl functional end groups on each end and the second lubricant composition comprises a perfluoropolyether polymer terminated with two hydroxyl functional end groups on each end.

9. The disk drive according to claim 1, wherein the at least one additional disk drive component is chosen from a voice coil, a spindle motor coil, a solenoid coil, a filter patch, a damper, a head gimbal assembly, a trace gimbal assembly, a pressure sensitive adhesive assembly, and combinations thereof.

10. The disk drive according to claim 1, wherein the second lubricant composition is present on at least a portion of an interior surface of the lid.

11. The disk drive according to claim 1, wherein the second lubricant composition is present on at least a portion of an interior surface of the base.

12. The disk drive according to claim 1, comprising:
a first additional disk drive component comprising a surface, wherein a second lubricant composition is present on at least a portion of the surface of the first additional disk drive component, wherein the second lubricant composition is miscible in the first lubricant composition; and
a second additional disk drive component comprising a surface, wherein a third lubricant composition is present on at least a portion of the surface of the second additional disk drive component, wherein the third lubricant composition is miscible in the first lubricant composition.
